(19) United States
(12) Patent Application Publication
(10) Pub. No.: US 2022/0083581 A1
(43) Pub. Date: Mar. 17, 2022

(54) TEXT CLASSIFICATION DEVICE, TEXT CLASSIFICATION METHOD, AND TEXT CLASSIFICATION PROGRAM

(71) Applicant: Hitachi, Ltd., Tokyo (JP)

(72) Inventors: Yasuhiro SOGAWA, Tokyo (JP); Misa SATO, Tokyo (JP); Kohsuke YANAI, Tokyo (JP)

(21) Appl. No.: 17/203,993

(22) Filed: Mar. 17, 2021

(30) Foreign Application Priority Data
Sep. 14, 2020 (JP) 2020-153561

(51) Int. Cl. G06F 16/35; G06F 16/33; G06F 40/205; G06F 40/279; G06F 40/242

(52) U.S. Cl. CPC G06F 16/355; G06F 16/3344; G06F 40/242; G06F 40/279; G06F 40/205

(57) ABSTRACT

A text classification device includes an important word extraction portion that extracts important words from analysis target text data, a distributed representation creation portion that creates distributed representations of words from related document data, a keyword candidate creation portion that extracts words near the important words as synonyms in the distributed representations of the words, a clustering portion that clusters the distributed representations of the important words and synonyms and creates a term cluster, and a viewpoint word creation portion that extracts a hypernym that is a word having a generalized concept of a term in the term cluster using a knowledge base in which relationships between terms are accumulated and creates a viewpoint dictionary in which a viewpoint word selected from the hypernyms is set as a headword and the terms included in the term cluster are set as keywords for the headword.

### CROSS-REFERENCE TO RELATED APPLICATION

This application claims priority to Japanese Patent Application No. 2020-153561 filed on Sep. 14, 2020, the entire contents of which are incorporated by reference herein.

### BACKGROUND OF THE INVENTION

The present invention relates to a text classification device, a text classification method, and a text classification program.

The text logs include conversation logs in an automated dialog service such as a chatbot, dictations based on conversations in a call center, and inquiry mails about services, products, etc. Text logs are coming to be accumulated in various tasks. These logs are thought to include important needs and complaints about business. The contents of these logs are expected to be analyzed and to be used for improvement in quality of products and services. However, a huge quantity of such text logs continues to be accumulated in daily tasks. Comprehensive reading and analysis of the logs by persons are burdensome, causing difficulty.

On the other hand, various text classification methods that classify and sort texts have been proposed. The topic modeling is a typical text classification method (Wallach and H. M. “Topic modeling: beyond bag-of-words” Proceedings of the 23rd international conference on Machine learning, 2006). In the topic modeling, based on the types and occurrence frequencies of words in texts, potential topics in a text group are extracted to classify the texts.

### SUMMARY OF THE INVENTION

Realization of Automatic analysis of huge quantity of text logs is expected by using a text classification method. However, the following problems occur.

(1) In text classification using the topic model, texts are clustered based on the types and occurrence frequencies of words. Such classification methods do not indicate what viewpoint is included in a clustered text group. To extract needs or complaints as final targets of analysis of text logs, it is necessary to recognize viewpoints in the text group. With respect to what viewpoint on which text classification is based, it is necessary to manually check the classification result. The burden on the analyzer is still heavy.

(2) In the text classification using the topic model, texts are clustered based on the types and occurrence frequencies of words. A long text (for example, includes ten or more sentences) is thus desirable. However, since conversation logs, inquiry mails, etc. include short sentences in many cases, statistical reliability tends to be low in the technique of statistical approach using the entire texts. There is a concern that high analytical accuracy is not acquired.

A text classification device of one embodiment of the present invention is a text classification device that classifies texts included in text logs. The text classification device includes an important word extraction portion that extracts important words from analysis target text data, a distributed representation creation portion that creates distributed representations of words from related document data, a keyword candidate creation portion that extracts words located near an important word in the distributed representations of words as synonyms, a clustering portion that execute clustering of the distributed representations of important words and synonyms to create a term cluster, and a viewpoint word creation portion that extracts a hypernym that is a word having a generalized concept of a term included in the term cluster by using a knowledge base in which relationships between terms are accumulated, and creates a viewpoint dictionary in which a viewpoint word selected from the hypernyms is set as a headword and the terms included in the term cluster are set as keywords for the headword.

A text classification device and a classification method that automatically apply interpretable viewpoints to a huge number of text logs having short sentences are provided to achieve effective classification.

Other problems and new features will become clear from the description and the accompanying drawings of the present specification.

### BRIEF DESCRIPTION OF THE DRAWINGS

FIG. 1 illustrates an example of hardware configuration of a text classification device;

FIG. 2 illustrates programs and data stored in an auxiliary storage device;

FIG. 3 illustrates a framework of a text classification function;

FIG. 4 illustrates a flowchart of viewpoint dictionary creation processing;

FIG. 5 explains a method of extraction of synonyms;

FIG. 6 illustrates an example of two-dimensional visualization of distributed representations of words represented by rectangular shapes;

FIG. 7 explains a method of extraction a viewpoint word candidate group;

FIG. 8 illustrates a data structure of a viewpoint dictionary;

FIG. 9 illustrates a flowchart of viewpoint classification processing; and

FIG. 10 illustrates a data structure of viewpoint-attached text data.

### DETAILED DESCRIPTION OF THE PREFERRED EMBODIMENTS

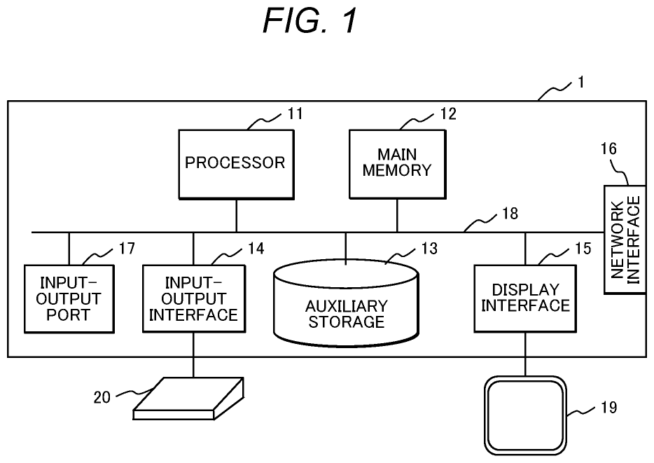

FIG. 1 illustrates an example of hardware configuration of a text classification device 1 of the present embodiment. The text classification device 1 includes a processor 11, a main memory 12, an auxiliary storage device 13, an input-output interface 14, a display interface 15, a network interface 16, and an input-output (I/O) port 17. These components are coupled using a bus 18. The input-output interface 14 is connected to an input device 20 such as a keyboard and a mouse, and the display interface 15 is connected to a display 19 to realize a GUI (Graphical User Interface). The network interface 16 is connected to a network to exchange information with other information processing devices connected to the network. In general, the auxiliary storage device 13 includes a nonvolatile memory such as an HDD (Hard Disk Drive) and an SSD (Solid State Drive) to store, e.g., programs executed by the text classification device 1 and data to be processed by the programs. The main memory 12 includes an RAM (Random Access Memory) to temporarily store programs and data required for execution of the programs in response to commands of the processor 11. The processor 11 executes programs loaded from the auxiliary storage device 13 to the main memory 12. The text classification device 1 is realizable, for example, by an information processing device such as a PC (Personal Computer) or a server.

The text classification device implemented in one server configured as in FIG. 1 is explained below as an example. The text classification device may be implemented in one server or distributed processing servers. The text classification device is not limited by a physical structure of hardware. The data processed by the text classification device 1 may not be necessarily stored in the auxiliary storage device 13. For example, the data may be stored in an object storage on a cloud and data paths to access target data may be stored in the auxiliary storage device 13.

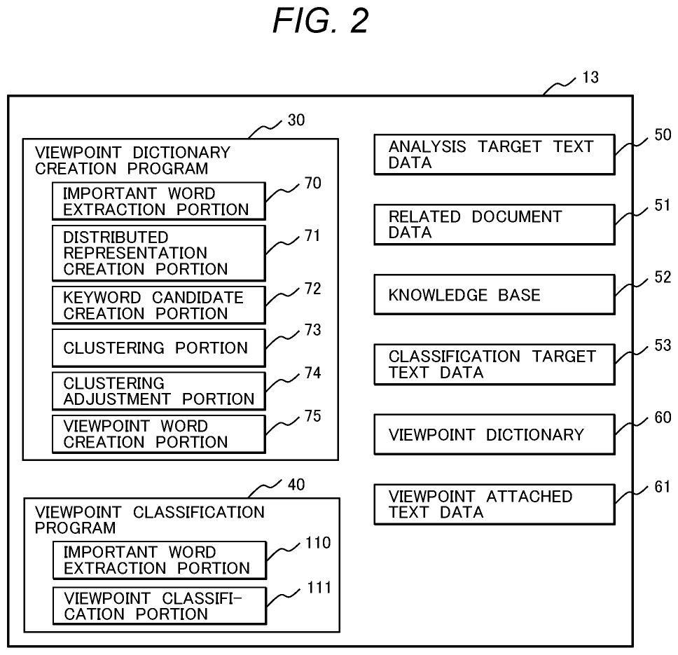

As shown in FIG. 2, a viewpoint dictionary creation program 30 and a viewpoint classification program 40 are stored in the auxiliary storage device 13. Programs stored to various media via an optical drive and an external HDD that are connected to an I/O port 17 or programs delivered via the network may be stored to the auxiliary storage device 13. The data used or created by the viewpoint dictionary creation program 30 or viewpoint classification program 40 is also stored in the auxiliary storage device 13. The programs and contents of these data pieces are mentioned later. The programs stored to the auxiliary storage device 13 are executed by the processor 11 to achieve predetermined processes of the functions of the text classification device 1 in cooperation with other hardware. The programs executed by a computer, etc., the functions of the programs, or the procedures that realize the functions may be called “functions,” “portions,” etc.

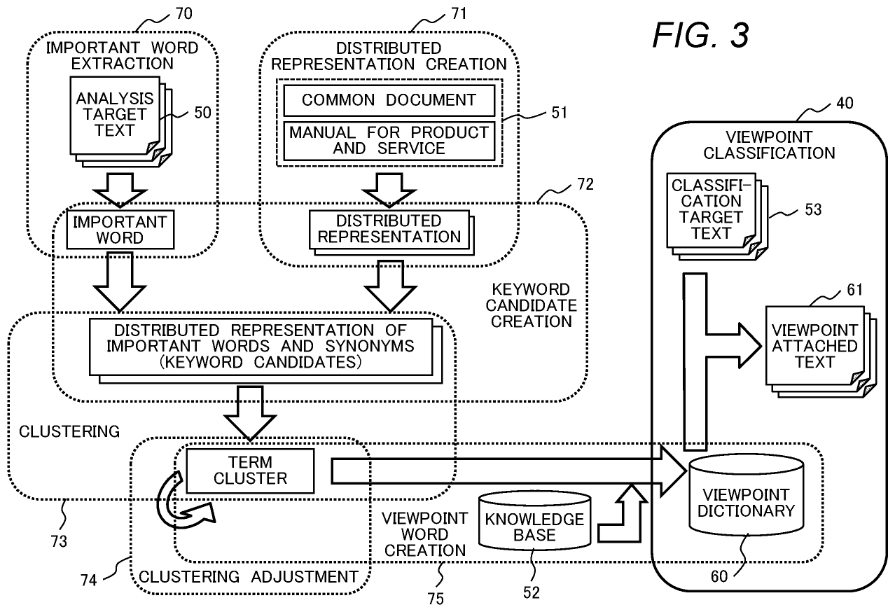

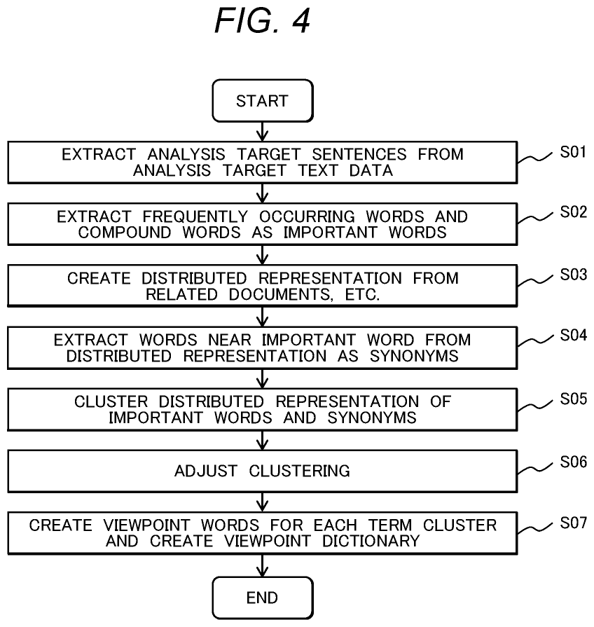

FIG. 3 illustrates a framework of a text classification function executed by the text classification device 1. FIG. 4 illustrates a flowchart of viewpoint dictionary creation processing executed by the viewpoint dictionary creation program 30 of the text classification device 1. The processing executed by the viewpoint dictionary creation program 30 performs is explained mainly in reference to FIGS. 2 to 4. The viewpoint dictionary creation program 30 further includes six subprograms (portions) 70 to 75.

(1) Important Word Extraction Portion 70

An important word extraction portion 70 extracts important words from analysis target text data 50. The analysis target text data 50 is accumulated data of text logs to be classified. When a quantity of text logs is small, accumulated data of similar text logs may also be used together. First, sentences to be analyzed are extracted from the analysis target text data 50 (S01). It is very common that greeting sentences, etc. are included in text logs. The greeting sentences, etc. are unnecessary for the analysis of extracting information about needs or complaints from the text logs. At Step S01, sentences to be analyzed (called important sentences) other than such unnecessary sentences are extracted. For example, based on structures of the sentences, request sentences (including “want to”) or question sentences (including “what is”) are extracted from text logs. Then, unnecessary sentences are removed and the important sentences likely to include useful information are extracted.

A morphological analysis is executed to the extracted important sentences. Then, frequently occurring words (including words and compound words, which are hereinafter collectively called “words” without being particularly distinguished hereinafter) are extracted from the extracted important sentences as important words (S02). The frequency of occurrence is one of criteria to select important words but not limiting.

The text logs include natural language sentences. If a dictionary uses only extracted important words as keywords, retrieval accuracy is low because similar representations are missed from retrieval by keywords limited to the extracted important words. The following processing is therefore executed to include synonyms similar to the important words in the keywords for classification.

(2) Distributed Representation Creation Portion 71

A distributed representation creation portion 71 creates distributed representations of words from the related document data 51. The distributed representation is a technology that represents words by high dimensional vectors. Synonyms are represented as the vectors close to each other. Some algorithms are known to acquire such distributed representations of words.

It is desirable to provide, as the related document data 51, the documents (for example, manuals) about the products and services relating to the classification target text logs in addition to common documents including common terms. It is thus also possible to extract synonyms of the terms unique to the products and services relating to the text logs.

(3) Keyword Candidate Creation Portion 72

A keyword candidate creation portion 72 extracts synonyms by using the important words extracted from the important word extraction portion 70 and the distributed representations created in the distributed representation creation portion 71 (S04). Distributed representations of important words and synonyms are thus acquired.

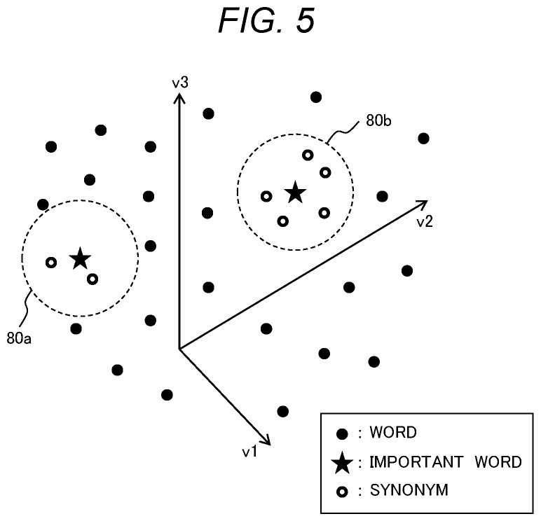

Extraction of synonyms is explained using FIG. 5. FIG. 5 schematically illustrates distributed representations of words created by the distributed representation creation portion 71. Words are arranged onto a vector space. A three-dimensional vector space is illustrated here. Actually, words are represented as vectors of hundreds of dimensions. Stars illustrate important words extracted by the important word extraction portion 70. Circles illustrate words other than the important words. Neighboring words are estimated to be synonyms in distributed representations of words. Then, a word having a cosine similarity to an important word equal to or over a predetermined threshold is extracted as a synonym of the important word. In FIG. 5, areas illustrated by the predetermined threshold are illustrated by spheres 80, and words in each sphere 80 are extracted as synonyms of a corresponding important word. In FIG. 5, the words extracted as synonyms are illustrated by open circles and the other words as closed circles. The words of the closed circles are removed from the vector space of FIG. 5 to acquire distributed representations of the important words and synonyms.

As below, important words and synonyms are used as keyword candidates of a viewpoint dictionary created in the present embodiment. A group of important words and synonyms may be called a keyword candidate.

(4) Clustering Portion 73

A clustering portion 73 executes clustering to the distributed representations of the important words and synonyms acquired in the keyword candidate creation portion 72 (S05). The acquired cluster is called a term cluster. For example, an algorithm such as K-means is applicable to the clustering. An analyzer sets a cluster number k appropriately.

(5) Clustering Adjustment Portion 74

Clustering using K-means can be automatically executed. The automatic clustering may not be enough for classification. In such a case, the analyzer adjusts clustering (S06). A manual adjustment technique of clustering (by the analyzer) is explained.

(5a) Visualization

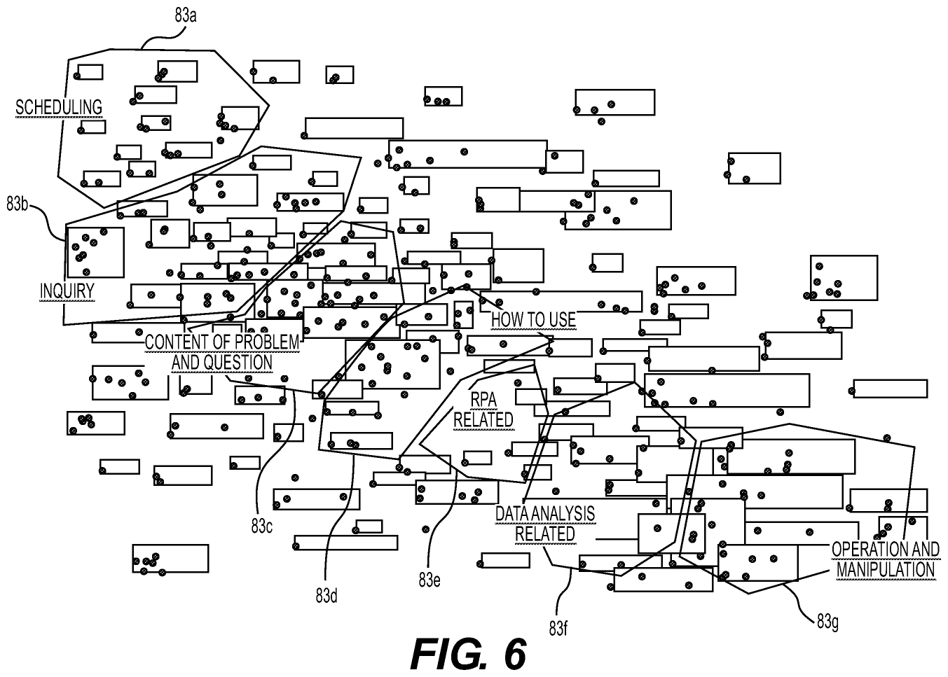

Words are represented as hundreds-dimensional vectors. It is therefore difficult for the analyzer to directly understand relationships between words on the vector space. Therefore, a high dimensional distributed representation is reduced in dimension and visualized onto a two-dimensional plane. UMAP and t-SNE are known as algorithms to two-dimensionally visualize a high dimensional distributed representation. These algorithms are applied to visualize the two-dimensional distribution and clustering of important words and synonyms represented by rectangular shapes as shown in FIG. 6. Clustered word groups are surrounded by frames 83. Seven term clusters indicated by frames 83a to 83g are acquired here. The analyzer can execute the following processing to the visualized two-dimensional distributed representation.

(5b) Addition of Unknown Word

It is difficult that some terms such as technical terms, specific terms, proper nouns, etc. are appropriately represented as vectors by automatic processing. Such words are collectively called unknown words. The analyzer plots such unknown words on a two-dimensional plane of a distributed representation.

(5c) Creation and Addition of Cluster

When the analyzer determines visually that it is appropriate that a word group is clustered, although the word group is not automatically clustered, the analyzer can add a term cluster by framing the word group on a two-dimensional plane of a distributed representation.

The unknown words added at (5b) are treated the same as the other words in the term cluster. The term cluster added at (5c) also is treated the same as the term cluster created by the clustering portion 73.

This clustering adjustment Step (S06) does not need to be necessarily executed after the clustering Step (S05). When the automatically created clustering is enough, the present step may be skipped. In contrast, after creation of a viewpoint dictionary or classification of classification target texts using a viewpoint dictionary, clustering may be newly adjusted based on a result of the creation or classification.

(6) Viewpoint Word Creation Portion 75

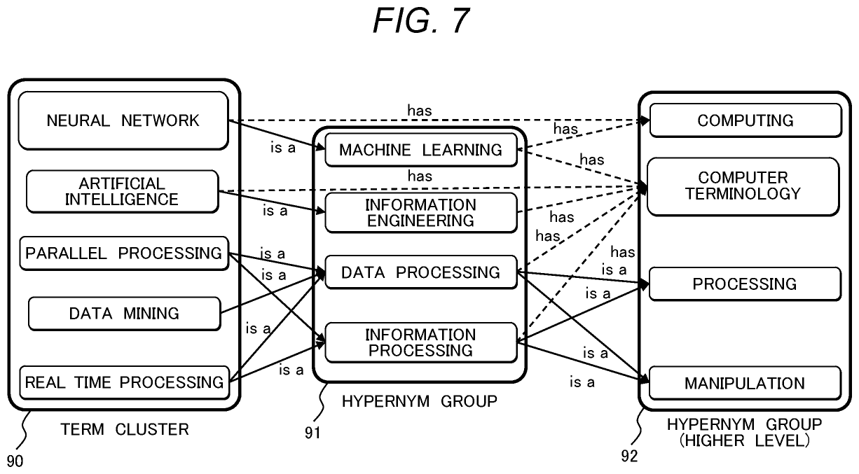

The viewpoint word creation portion 75 generates viewpoint words for each term cluster by use of a knowledge base 52 (S07). The knowledge base 52 is a database in which relationships between terms are accumulated in an expressible manner as a graph. The terminological relationships include multiple types such as is-a relationships (inheritance) and has-a relationships (containment). In the present embodiment, first, by following the is-a relationships from a term in the term cluster in reference to the knowledge base 52, a word (concept) having a generalized concept of the term is extracted as a so-called hypernym. A group of hypernyms are then a group of viewpoint words. Explanation is made using FIG. 7.

A hypernym group 91 having is-a relationships with the terms included in the term cluster 90 is extracted in reference to the knowledge base 52. A hypernym group (higher level) 92 having is-a relationships with the extracted hypernyms is further extracted. Hypernyms having is-a relationships with the extracted hypernyms (higher level) continues to be extracted if possible. Thus, the extracted hypernym group is set as viewpoint word candidates for the term cluster. In this example, the viewpoint word candidates including “machine learning,” “information engineering,” “data processing,” “information processing,” “processing,” and “manipulation” are acquired for the term cluster 90.

One or more words that appropriately indicate the content of the term cluster 90 are selected from the acquired viewpoint word candidates as the viewpoint words. Scores of the acquired viewpoint words are determined in order to select the viewpoint words for the term cluster. A frequently occurring word in the viewpoint word candidates may be a generalized concept common to the terms in the term cluster. A frequency of occurrence freqₛ of each term is calculated by the following (Expression 1). An optional number of viewpoint word candidates having a high value of the frequency of occurrence freqₛ are selected as viewpoint words.

freqₛ=u(w) [Expression 1]

Here, s is a viewpoint word candidate (hypernym), w is a term in the term cluster, and u(w) is the number of terms having is-a relationship with a viewpoint word candidate. For example in FIG. 7, in case of the viewpoint word candidate “data processing,” u(w)=3, and in case of the viewpoint word candidate “information processing,” u(w)=2.

In the calculation of the frequency of occurrence freqₛ using (Expression 1), the terms in the term cluster are treated equivalently. Based on the importance of the terms in the term cluster, the terms may be weighted to calculate the frequency of occurrence (score). An example is described below.

freqₛ^{weighted}=sim(c,w)·u(w) [Expression 2]

In Expression 2, a term is weighted higher toward the center of the term cluster and lower toward the edge of the term cluster to calculate a weighted frequency of occurrence freqₛ^{weighted}. This uses a cosine similarity sim (c, w) from a cluster center c to a term w as a weight.

freqₛ^{keywords}=f(w)·u(w) [Expression 3]

In (Expression 3), when a term in the term cluster has a higher frequency of occurrence in the analysis target text data 50, the term is weighted higher, and when a term in the term cluster has a lower frequency of occurrence in the analysis target text data 50, the term is weighted lower. A frequency of occurrence freqₛ^{keywords} of a weighted keyword is then calculated. The frequency of occurrence f(w) of the term w in the analysis target text data is used as a weight. Frequencies of occurrences of synonyms in the terms w may use those of corresponding important words.

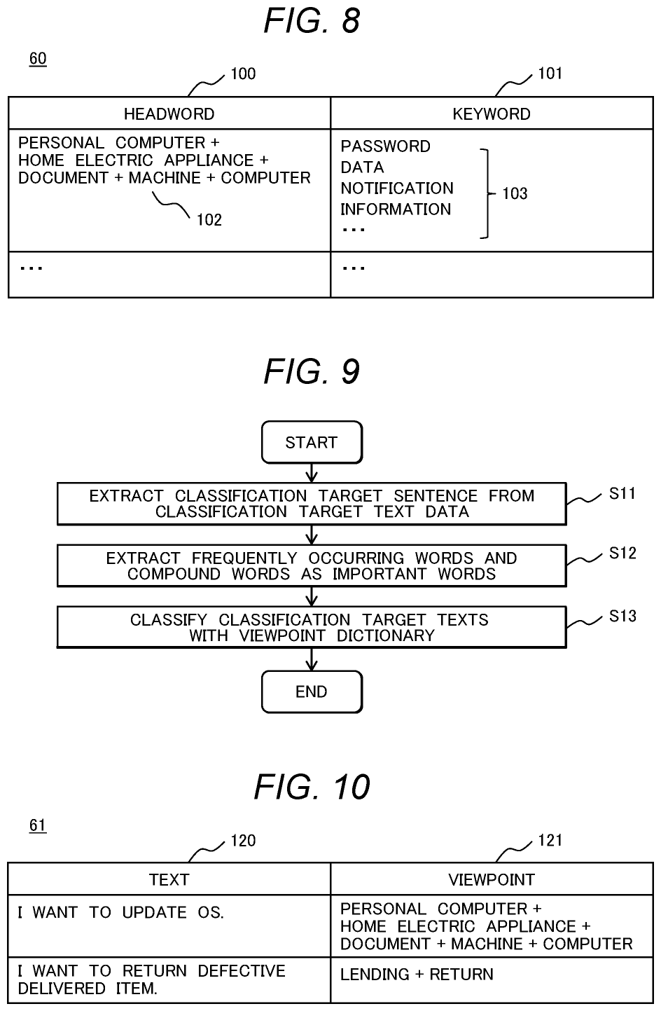

As above, the viewpoint words indicated by each term cluster are created for the term cluster. A viewpoint dictionary 60 is then created to associate viewpoint words corresponding to each cluster. FIG. 8 illustrates a data structure of the viewpoint dictionary 60 created by the above processing. The viewpoint dictionary 60 includes a headword column 100 and a keyword column 101. The headword column 100 includes viewpoint words 102 created for the term cluster by the viewpoint word creation portion 75. The keyword column 101 includes terms (important words, synonyms) 103 in the term cluster.

An example of creating viewpoint words based on is-a relationships (inheritance) has been explained here. Viewpoint words may be created based on a different relationship such as a has-a relationship (containment). The processing is the same as the above explained one. Viewpoint attachment based on a specific relationship is thus possible. The viewpoint words based on is-a relationships (inheritance) and the viewpoint words based on has-a relationships (containment) may be created to create multiple types of viewpoint dictionaries. The analyzer may check, add, or correct viewpoint words.

Mainly referring to FIGS. 2, 3, and 9, the processing executed by the viewpoint classification program 40 is explained. FIG. 9 is a flowchart of viewpoint classification executed by the viewpoint classification program 40 of the text classification device 1. The viewpoint classification program 40 further includes two subprograms (portions) 110 to 111.

(1) Important Word Extraction Portion 110

An important word extraction portion 110 extracts sentences to be classified (classification target text) from the classification target text data 53 (S11). The important word extraction portion 110 executes morphological analysis to the extracted important sentences to extract frequently occurring words (including words and compound words) as important words (S12). The present processing is the same in processing content as the processing executed by the important word extraction portion 70 except that only the processing target texts are different. Therefore, the same explanation is not repeated.

The processing of the important word extraction portion 110 may be simplified. Without extracting important sentences, words (terms) extracted by executing a morphological analysis to classification target texts may be used for the processing of a viewpoint classification portion 111 mentioned below.

(2) Viewpoint Classification Portion 111

A viewpoint classification portion 111 matches the important words extracted from the classification target text with the keywords of the viewpoint dictionary 60, then calculates a score of each headword to create viewpoint-attached text data 61 in which headwords having a highest score in the classification target text are associated as viewpoints for the important sentence (S13).

A score s₁ of a headword 1 is calculated, for example, by (Expression 4). In the viewpoint dictionary 60, a keyword group W₁ associated with the headword 1 and an important word (term) t extracted from one classification target text by the important word extraction portion 110 are set as a group T.

$${s}_{l} = {\sum }_{w ∈ {W}_{i}} {\sum }_{t ∈ T} {i}_{tw} \\ {i}_{tw} = 1 if t = w , otherwise 0 \qquad [ Expression 4 ]$$

By associating the viewpoint words that are the headwords 1 having the highest score s₁ as viewpoint words for the classification target text, the viewpoint-attached text data 61 is created. FIG. 10 illustrates a data structure of the viewpoint-attached text data 61. The viewpoint-attached text data 61 includes a text column 120 and a viewpoint column 121. Classification target texts are registered to the text column 120 and viewpoint words are registered into the viewpoint column 121. The registered viewpoint words are the headwords of the viewpoint dictionary 60, the headwords each having the highest score s₁.

As above, the present invention has been explained based on the embodiment and the modification. The present invention is not limited to the above embodiment and modification. Various modifications may be made without departing from the scope of the invention. For example, when multiple viewpoint dictionaries are created based on different relationships, viewpoint-attached text data corresponding to each viewpoint dictionary is created. As a result, when trying to extract needs and complaints in classification target texts, the analyzer can distinguish viewpoints of texts classified based on each relationship, for example, a viewpoint of the text classified based on inheritance and a viewpoint of the text classified based on containment, even though the viewpoints are the same as each other.

### REFERENCE SIGNS LIST

1: Text classification device
11: Processor
12: Main memory
13: Auxiliary storage
14: Input-output interface
15: Display interface
16: Network interface
17: Input-output port
18: Bus
19: Display
20: Input device
30: Viewpoint dictionary creation program
40: Viewpoint classification program
50: Analysis target text data
51: Related document data
52: Knowledge base
53: Classification target text data
60: Viewpoint dictionary
61: Viewpoint-attached text data
70: Important word extraction portion
71: Distributed representation creation portion
72: Keyword candidate creation portion
73: Clustering portion
74: Clustering adjustment portion
75: Viewpoint word creation portion
100: Headword column
101: Keyword column
110: Important word extraction portion
111: Viewpoint classification portion
120: Text column
121: Viewpoint column

What is claimed is:

1. A text classification device that classifies texts included in a text log, the device comprising:
an important word extraction portion that extracts important words from analysis target text data;
a distributed representation creation portion that creates distributed representations of words from related document data;
a keyword candidate creation portion that extracts words located near the important word in the distributed representations of words as synonyms;
a clustering portion that executes clustering to the distributed representations of the important words and the synonyms to create a term cluster; and
a viewpoint word creation portion that extracts a hypernym that is a word having a generalized concept of a term included in the term cluster by using a knowledge base in which relationships between terms are accumulated, and creates a viewpoint dictionary in which a viewpoint word selected from the hypernyms is set as a headword and the terms included in the term cluster are set as keywords for the headword.

2. The text classification device according to claim 1, comprising:
a term extraction portion that extracts terms included in one text of classification target text data, and
a viewpoint classification portion that matches the terms extracted in the term extraction portion with the keywords of the viewpoint dictionary, calculates a score of each of the headwords of the viewpoint dictionary, and associates headword having a highest score as viewpoint for the one text.

3. The text classification device according to claim 1, wherein the important word extraction portion extracts a text having a predetermined sentence structure from texts included in the analysis target text data as an important sentence and selects a word extracted by executing a morphological analysis to the important sentence based on a frequency of occurrence of the extracted word as the important word.

4. The text classification device according to claim 1, wherein the viewpoint word creation portion selects the viewpoint word from the hypernyms extracted using the knowledge base based on frequencies of extractions of the hypernyms in the corresponding term cluster.

5. The text classification device according to claim 1, comprising a clustering adjustment portion that adjusts the term cluster created by the clustering portion,
wherein the clustering adjustment portion reduces dimensions of the distributed representations of the important words and the synonyms, and visualizes the distributed representations on a two-dimensional plane.

6. The text classification device according to claim 5, wherein addition of an unknown word to the term cluster or addition of a new term cluster are possible in the two-dimensionally visualized distributed representations of the important words and the synonyms.

7. The text classification device according to claim 1, wherein a relationship between terms in the knowledge base is an is-a relationship.

8. The text classification device according to claim 2,
wherein the knowledge base accumulates a plurality of types of relationships between terms including a first and second relationships, and
the viewpoint word creation portion creates a first viewpoint dictionary based on the first hypernym extracted based on the first relationship and a second viewpoint dictionary based on the second hypernym extracted based on the second relationship.

9. The text classification device according to claim 8, wherein the viewpoint classification portion associates the headwords of the first viewpoint dictionary and the second viewpoint dictionary as viewpoints for the one text.

10. The text classification device according to claim 1, wherein the related document data includes common documents and documents relating to products and services relating to the text logs.

11. A method of classifying texts included in text logs by using a text classification device comprises an important word extraction portion, a distributed representation creation portion, a keyword candidate creation portion, a clustering portion, and a viewpoint word creation portion, comprises the steps of:
extracting important words from analysis target text data by the important word extraction portion,
creating distributed representations of words from related document data by the distributed representation creation portion,
extracting words located near the important word in the distributed representations of words as synonyms by the keyword candidate creation portion,
executing clustering to the distributed representations of the important words and the synonyms to create a term cluster by the clustering portion, and
extracting hypernyms that are each a word having a generalized concept of a term included in the term cluster by using a knowledge base in which relationships between terms are accumulated, and creating a viewpoint dictionary in which a viewpoint word selected from the hypernyms is set as a headword and the terms included in the term cluster are set as keywords for the headword, by the viewpoint word creation portion.

12. The method according to claim 11,
wherein the text classification device further comprises a term extraction portion and a viewpoint classification portion, further comprises the steps of:
extracting terms included in one text of classification target text data by the term extraction portion, and
matching the terms extracted by the term extraction portion with the keywords of the viewpoint dictionary to calculate a score of each of the headwords of the viewpoint dictionary and associating headword having a highest score as viewpoint for the one text by the viewpoint classification portion.

13. A text classification program that classifies texts included in a text log, the program making an information processing device execute:
a procedure of extracting important words from analysis target text data;
a procedure of creating distributed representations of words from related document data;
a procedure of extracting words located near the important words in the distributed representations of the words as synonyms;
a procedure of executing clustering to the distributed representations of the important words and the synonyms to create a term cluster; and
a procedure of extracting a hypernym that is a word having a generalized concept of a term included in the term cluster by using a knowledge base in which relationships between terms are accumulated and creating a viewpoint dictionary in which a viewpoint word selected from the hypernyms is set as a headword and the terms included in the term cluster are set as keywords for the headword.

14. The text classification program according to claim 13, the program that making the information processing device further execute:
a procedure of extracting terms included in one text of classification target text data; and
a procedure of matching the extracted terms with the keywords of the viewpoint dictionary, calculating a score of each of the headwords of the viewpoint dictionary, and associating headword having a highest score as viewpoint for the one text.
